(19) United States
(12) Patent Application Publication
(10) Pub. No.: US 2010/0076894 A1
(43) Pub. Date: Mar. 25, 2010

(54) SYSTEM AND METHOD FOR ACQUIRING AND DISTRIBUTING ADVERTISEMENT IMPRESSIONS

(75) Inventor: R. Preston McAfee, San Marino, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/234,752

(22) Filed: Sep. 22, 2008

(51) Int. Cl. G06Q 30/00

(52) U.S. Cl. 705/80

(57) ABSTRACT

The present invention provides a method and system for acquiring and distributing a plurality of advertising impressions. The method and system includes determining a number of advertisement impressions requested to satisfy a plurality of advertisement contracts under management in an electronic advertisement system. The method and system includes bidding, in an bid exchange, for a plurality of advertisement impressions to win the number of advertisement impressions requested, the bidding using a randomized exchange purchasing strategy for the placement of a plurality of bids in the bid exchange, the bidding performed using a decentralized implementation. And the method and system includes, upon acquisition of advertisement impressions from the exchange, allocating the advertisement impressions proportionally to each of the plurality of advertisement contracts.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to an electronic advertisement system and more specifically to acquiring, through a bidding process, a plurality of advertisement impressions and allocation of impressions to a plurality of advertising contracts.

### BACKGROUND OF THE INVENTION

The World Wide Web provides access to an extraordinary large collection of information sources (in various formats including text, images, videos and other media content) relating to virtually every subject imaginable. Advertising has become the economic foundation of the World Wide Web, with nearly all non-transactional websites relying on revenue generated by the placement of advertisements as a primary source of income. Traditionally, advertisers have a pre-existing agreement with a website operator or a search engine provider to display online advertisements in association with one or more selected web pages. Online advertisements are usually displayed on web pages as a result of a request for one or multiple advertisements by advertisement tags that are associated with web pages provided by publishers. The requests for advertisements and the subsequent display on web pages are usually handled by an ad serving system.

The advertisement impressions can be managed by an intermediary, including managing impressions in response to contractual obligations between the advertiser and the ad serving system. There are techniques for executing guaranteed contracts to insure that the correct number of impressions is acquired and that advertisement impressions are then generated. These solutions for executing guaranteed contracts often involve randomization, to meet quantity objectives, spend limits or as a strategy to insure quality. Randomized strategies may be analogized to mutual funds, insuring quality by preventing a single advertising campaign from receiving only the “bad” impressions.

Additionally, in a second price auction, a fully random strategy would involve some probability of an infinite bid. This is an extremely dangerous strategy because if two bidders adopt it, it is highly probable that they will become bankrupt, where their financial reserves relate to the amount of funds available to bid on the impressions on an exchange.

In most settings then, randomized strategies will involve a probability that is a function of price. For example, a campaign might target a proportion y(p) of impressions that sell for a price p; this is implementable in the second price auction context by using a randomized bidding distribution 1−y(p). The function 1−y is a distribution provided y in non-increasing, i.e. the campaign does not try to purchase a higher proportion of the expensive impressions than it purchases of less expensive impressions.

As the intermediary manages the different accounts, there exists a need for acquiring and distributing the advertisement impressions to contracts under management.

### SUMMARY OF THE INVENTION

The present invention provides a method and system for acquiring and distributing a plurality of advertising impressions. The method and system includes determining a number of advertisement impressions requested to satisfy a plurality of advertisement contracts under management in an electronic advertisement system. The method and system includes bidding, in an bid exchange, for a plurality of advertisement impressions to win the number of advertisement impressions requested, the budding using a randomized exchange purchasing strategy for the placement of a plurality of bids in the bid exchange, the bidding performed using a decentralized implementation. And the method and system includes, upon acquisition of advertisement impressions from the exchange, allocating the advertisement impressions proportionally to each of the plurality of advertisement contracts.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a processing system including a system for acquiring and distributing a plurality advertisement impressions;

FIG. 2 illustrates a block diagram of one embodiment of a system for acquiring and distributing a plurality of advertisement impressions; and

FIG. 3 illustrates a flowchart of the steps of one embodiment of a method for allocating and distributing a plurality of advertisement impressions.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

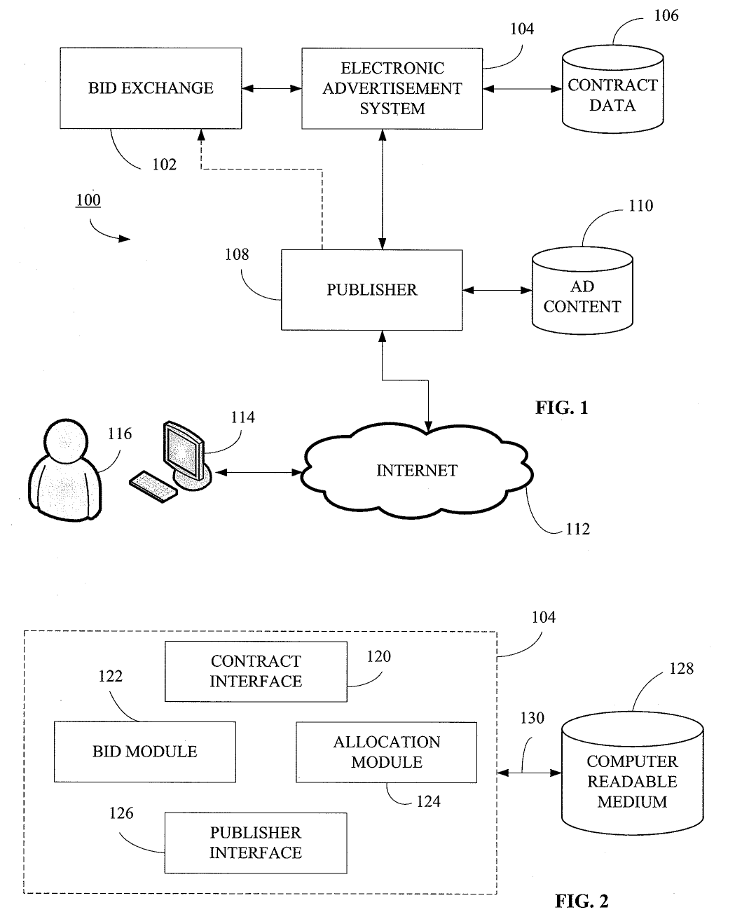

FIG. 1 illustrates a system 100 that includes an impression bid exchange 102, an electronic advertisement system 104, a contract data database 106, a publisher 108 and an ad content database 110. The system 100 also includes a network connection 112, user computer 114 and user 116.

The bid exchange 102 may be any suitable type of network, device or system for bidding on advertisement impressions. This network 102 is accessible by any number of processing devices such that they may place competitive bids on advertisement impressions. The bid exchange may operate in accordance with known auctioning or exchange techniques, as recognized by one skilled in the relevant arts.

The electronic advertisement system 104 may be one or more processing devices operative to perform management operations as described in further detail below. The system 104 may include the performance of these operations in response to executable instructions from a computer readable medium. The system 104 may include any suitable number of processing components operative to perform the operations in a central or distributed computing manner.

The contract data database 106 and the ad content database 110 may be one or more data storage devices operative to store data therein. The databases 106 and 110 may be in a local environment or accessible across a networked environment in accordance with any suitable technique known to those skilled in the art.

The publisher 108 may be any suitable type of processing environment operative to publish content such that advertisement impressions are presented therewith. By way of example, the publisher may be a media publisher, such as a web location for a news organization, whereby the user 116 accesses the publisher 108 using the computer 114 via the network 112. The publisher 108, upon publication, includes advertising content from the ad content 110. The publisher 108 may operate in accordance with known publishing operations, including adding advertising content in accordance with known techniques recognized by one skilled in the art.

In the system 100, the electronic advertisement system 104 includes processing components for performing operations providing for the acquisition and distribution of advertisement impressions. The advertisement system 104 may operate as an intermediary between a plurality of contracts, each of the contracts having contract terms for specific types of advertisements.

In a typical embodiment, the contract terms include terms for a budget relating to how much money an advertiser is willing to spend, as well as the conditions the advertiser is seeking for ad placement. For example, this may include an advertiser wishing to target a customer having specific credentials or associate the advertisement with particular content. The conditions of the contracts are managed for various purposes, including terms under which the system 104 may then place bids in the bid exchange 102. The system 104 is operative to manage any number of contracts from the database 106, whereby the system 104 is operative to provide for the acquisition of impressions from the bid exchange 102 to satisfy the contracts, as well as to allocate or distribute the impressions to the different contracts in a fair manner.

FIG. 2 illustrates another embodiment of the electronic advertisement system 104, including the contract interface 120, the bid module 122, the allocation module 124 and the publisher interface 126. Further illustrated in FIG. 2 is a computer readable medium 128 having executable instructions 130 stored thereon. The interfaces 120, 126 and modules 122, 124 may perform processing operations in response to the executable instructions 130 from the computer readable medium.

In the system 100 of FIG. 1, the system 104 is operative to acquire the proper number of bids using the bidding module 122 of FIG. 2 engaging the bid exchange 102. The system 104 recognizes and manages the amount of impressions to acquire based on the contract interface 120 being in communication with the contract data. The allocation module 124 is operative to allocate the impressions to the different contracts in a fair manner and the publisher interface 126 provides for the publisher providing the impressions to the user in accordance with the bidded terms from the network 102.

It is noted that in FIG. 1, the publisher 108 may be in communication with the network 102 for the sharing of impression information, for example providing the bid exchange 102 with market information about the number of impressions that are available for bidding. It is also noted that the components in FIG. 1 may also be integrated in a single system, with the publisher 108 having its own bid exchange 102 and ad management system 104, or they may be separate processing devices as illustrated herein.

The electronic advertisement system 104 may accomplish various benefits by bidding on behalf of a group of advertisers in the exchange 102. The intermediary, the system 104, may be able to purchase a group of impressions and allocate only the expensive ones to one campaign and the cheaper ones to another campaign. This allocation is not feasible using a decentralized allocation, that is where individual campaigns bid, unless a campaign can somehow buy impressions, keep some of them and resell the rest. Another benefit of the intermediate system 104 is the suppression of the price relative to decentralized allocations.

The system 104, through the bid module 122 and the allocation module 124 is operative to provide the decentralization of randomized strategies. For example, suppose that the system 104 purchases impressions in the bid exchange 102 and then allocates them to a set of campaigns so that of the impressions that sell for price p, campaign j obtains the proportion yⱼ(p). Therefore, Y(p) is denoted by Equation 1.

$$Y ( p ) = {\sum }_{j} {y}_{i} ( p ) \qquad Equation 1$$

Assume that Y in non-increasing, since the impressions are purchased on the exchange 102. A decentralized implementation will use distributions Hⱼ to bid for impressions. This means that campaign j wins an impression that receives a price from others as defined by Equation 2.

$${y}_{j} ( p ) = {\int }_{p}^{∞} ( {\prod }_{k \neq j} {H}_{k} ( b ) ) {h}_{j} ( b ) d b \qquad Equation 2$$

If it is assumed that every function yₖ is differentiable, this generates Equation 3.

$${y}_{j}^{′} ( p ) = - ( {\prod }_{k \neq j} {H}_{k} ( p ) ) {h}_{j} ( p ) = - ( {\prod }_{k} {H}_{k} ( p ) ) \frac{{h}_{j} ( p )}{{H}_{j} ( p )} \qquad Equation 3$$

A necessary condition for decentralization is that yⱼ is non-increasing for all j. As used herein, non-increasing means that after the purchase of a first impression, the campaign does not attempt to purchase more of the expensive impressions. Since

$${\prod }_{k} {H}_{k} ( P )$$

is the probability that none of the campaigns win an impression at price p, this generates Equation 4.

$${\prod }_{k} {H}_{k} ( p ) = 1 - {\sum }_{k} {y}_{k} ( p ) = 1 - Y ( p ) \qquad Equation 4$$

Thus, provided that Y(p)<1, this generates Equation 5.

$$\frac{{y}_{j}^{′} ( p )}{1 - Y ( p )} = \frac{{h}_{j} ( p )}{{H}_{j} ( p )} \qquad Equation 5$$

Integrating Equation 5 provides Equation 6.

$${\int }_{p}^{∞} \frac{{y}_{j}^{′} ( b )}{1 - Y ( b )} d b = - {\int }_{p}^{∞} \frac{{h}_{j} ( b )}{{H}_{j} ( b )} d b = Log ( {H}_{j} ( p ) ) \qquad Equation 6$$

Thus, Equation 7 provides the bidding distribution for advertisers to obtain campaign objectives in the presence of other advertisers, allowing for the system 104 to manage multiple advertising campaigns.

$${H}_{j} ( p ) = {e}^{{\int }_{p}^{∞} \frac{{y}_{j}^{′} ( b )}{1 - Y ( b )} d b} . \qquad Equation 7$$

Thereby, in the system 104, if yⱼ is non-increasing for all j, it can be decentralized using the bidding distribution of Equation 7 for p such that Y(p)<1. At Equation 8: p*=inf{p|Y(p)<1}, at least on one of H's must be zero because

$${\prod }_{k} {H}_{k} ( p ) = 1 - Y ( p ) . \qquad Equation 9$$

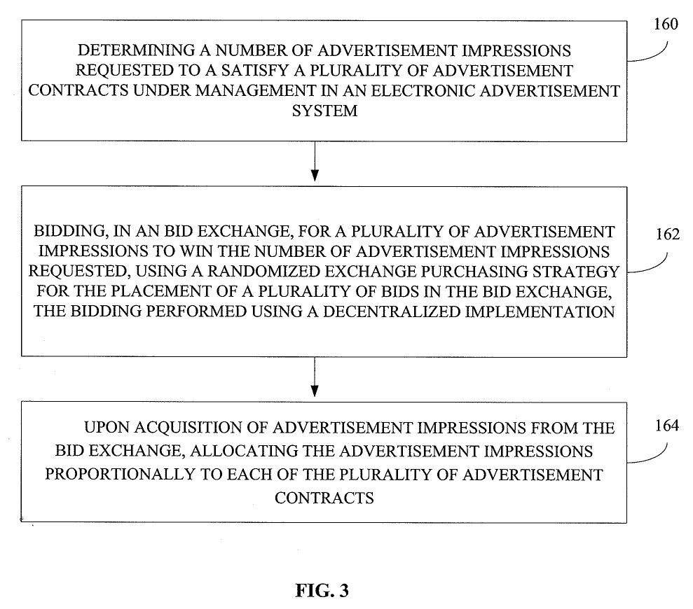

FIG. 3 illustrates a method for the acquiring and distributing a plurality of advertisement impressions. The method may be implemented by the system 104, as described above. The method includes, step 160, determining a number of advertisement impressions requested to satisfy a plurality of advertisement contracts under management in the electronic advertisement system. This step may include a recognition of the different numbers of impressions that should be acquired from the bid exchange, including the financial conditions associated with the contracts. This provides for the collective management of multiple numbers of contracts through the intermediary.

A next step, step 162, is to bid in the bid exchange for a plurality of advertisement impressions to win the number of impressions requested. In this step, the bidding is performed using a randomized exchange purchasing strategy for the placement of bids in the bid exchange, the bidding performed using a decentralized implementation. This decentralized implementation performed consistent with calculations and processing techniques described in the equations above.

In this embodiment, a final step, step 164, is upon acquisition of advertisement impressions, allocating the impressions proportionally to each of the advertisement contracts. The allocation again performed in accordance with the calculations described in the above equations.

In one embodiment, the method includes the generation of advertisements based on the impressions acquired from the exchange. For example, with respect to FIG. 1, this may include the generation of an output display by the publisher 108 to the user 116, the publisher 108 including advertisement from the ad content database 110, the selected advertisement based on the acquired impression from the bid exchange 102.

In one embodiment, the usage of the decentralized implementation includes determining a percentage of impressions needed to purchase to satisfy the plurality of advertisement contracts, the purchase of impressions based on the placement of a winning bid in the bid exchange. The percentage of impression may be noted by the value Y(p) of Equation 1. It is noted that in one embodiment, for the processing of the calculations as disclosed herein, the percentage (the value of Y(p)) is less than one hundred percent, indicating a plurality of contracts.

In one embodiment the method of FIG. 3 may further include determining a bidding distribution for the plurality advertisement contracts based on a probability that none of the advertisement contracts win an advertisement in the bidding at a first price and the percentage of impressions needed.

As such, through the above-described system and method, the electronic advertisement system 104 is operative to manage a plurality of contracts through the acquisition and distribution of impressions from a bid exchange.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for acquiring and distributing a plurality of advertisement impressions, the method comprising:
determining a number of advertisement impressions requested to a satisfy a plurality of advertisement contracts under management in an electronic advertisement system;
bidding, in an bid exchange, for a plurality of advertisement impressions to win the number of advertisement impressions requested, using a randomized exchange purchasing strategy for the placement of a plurality of bids in the bid exchange, the bidding performed using a decentralized implementation; and
upon acquisition of advertisement impressions from the bid exchange, allocating the advertisement impressions proportionally to each of the plurality of advertisement contracts.

2. The method of claim 1 further comprising:
generating a plurality of advertisements based on the advertisement impressions acquired from the bid exchange.

3. The method of claim 1, wherein the bidding performed using a decentralized implementation comprises determining a percentage of impressions needed to purchase to satisfy the plurality of advertisement contracts, the purchase of the impression based on the placement of a winning bid in the bid exchange.

4. The method of claim 3, wherein the percentage is less than one hundred percent.

5. The method of claim 4 further comprising:
determining a bidding distribution for the plurality of advertisement contracts based on a probability that none of the advertisement contracts win an advertisement impression in the bidding at a first price and the percentage of impressions needed.

6. The method of claim 5, wherein the percentage of requested advertisement impressions is non-increasing.

7 A system for acquiring and distributing a plurality of advertisement impressions, the system comprising:
computer readable medium having executable instructions stored thereon;
a processing device, in response to the executable instructions, operative to:
determine a number of advertisement impressions requested to a satisfy a plurality of advertisement contracts under management in an electronic advertisement system;
bid, in an bid exchange, for a plurality of advertisement impressions to win the number of advertisement impressions requested, using a randomized exchange purchasing strategy for the placement of a plurality of bids in the bid exchange, the bidding performed using a decentralized implementation; and
upon acquisition of advertisement impressions from the bid exchange, allocate the advertisement impressions proportionally to each of the plurality of advertisement contracts.

8. The system of claim 7, the processing device is further operative to:
generate a plurality of advertisements based on the advertisement impressions acquired from the bid exchange.

9. The system of claim 7, wherein the bidding performed using a decentralized implementation comprises determining a percentage of impressions needed to purchase to satisfy the plurality of advertisement contracts, the purchase of the impression based on the placement of a winning bid in the bid exchange.

10. The system of claim 9, wherein the percentage is less than one hundred percent.

11. The system of claim 10, the processing device further operative to:
determine a bidding distribution for the plurality of advertisement contracts based on a probability that none of the advertisement contracts win an advertisement impression in the bidding at a first price and the percentage of impressions needed.

12. The system of claim 11, wherein the percentage of requested advertisement impressions is non-increasing.

13. Computer readable media comprising program code that when executed by a programmable processor causes execution of a method for acquiring and distributing a plurality of advertisement impressions, the computer readable media comprising:
program code for determining a number of advertisement impressions requested to a satisfy a plurality of advertisement contracts under management in an electronic advertisement system;
program code for bidding, in an bid exchange, for a plurality of advertisement impressions to win the number of advertisement impressions requested, using a randomized exchange purchasing strategy for the placement of a plurality of bids in the bid exchange, the bidding performed using a decentralized implementation; and
program code for, upon acquisition of advertisement impressions from the bid exchange, allocating the advertisement impressions proportionally to each of the plurality of advertisement contracts.

14. The computer readable medium of claim 13 further comprising:
program code for generating a plurality of advertisements based on the advertisement impressions acquired from the bid exchange.

15. The computer readable medium of claim 13, wherein the bidding performed using a decentralized implementation comprises determining a percentage of impressions needed to purchase to satisfy the plurality of advertisement contracts, the purchase of the impression based on the placement of a winning bid in the bid exchange.

16. The computer readable medium of claim 15, wherein the percentage is less than one hundred percent.

17. The computer readable medium of claim 16 further comprising:
program code for determining a bidding distribution for the plurality of advertisement contracts based on a probability that none of the advertisement contracts win an advertisement impression in the bidding at a first price and the percentage of impressions needed.

18. The computer readable medium of claim 17, wherein the percentage of requested advertisement impressions is non-increasing.
